(19) United States
(12) Patent Application Publication
(10) Pub. No.: US 2020/0393190 A1
(43) Pub. Date: Dec. 17, 2020

(54) REFRIGERATOR

(71) Applicant: SAMSUNG ELECTRONICS CO., LTD., Suwon-si, Gyeonggi-do (KR)

(72) Inventors: Nam Gu CHOI, Suwon-si (KR); Sang Gyu JUNG, Suwon-si (KR); Sang Chul RYU, Suwon-si (KR)

(73) Assignee: SAMSUNG ELECTRONICS CO., LTD., Suwon-si, Gyeonggi-do (KR)

(21) Appl. No.: 16/975,288

(22) PCT Filed: Feb. 20, 2019
(86) PCT No.: PCT/KR2019/002013

§ 371 Date: Aug. 24, 2020

(30) Foreign Application Priority Data
Feb. 23, 2018 (KR) 10-2018-0021770

(51) Int. Cl. F25D 23/02; E05D 11/06

(52) U.S. Cl. CPC F25D 23/028; E05D 11/06; F25D 2323/024; F25D 2323/021; E05Y 2900/31; F25D 2323/023

(57) ABSTRACT

A refrigerator includes a main body, a storage chamber formed inside the main body, a door coupled to the main body to open and close the storage chamber, and a hinge coupled to the main body to rotatably support the door, the door includes a lower plate forming a lower surface of the door and a door cap coupled to the lower plate and having a hinge groove, the hinge includes a shaft inserted into the hinge groove, and the shaft includes a door closing preventer configured to prevent the door from being automatically closed in a state in which the door is opened.

### TECHNICAL FIELD

The present disclosure relates to a refrigerator including a door closing preventer to prevent a phenomenon in which a door is automatically closed in a state of being opened.

### BACKGROUND ART

Generally, a refrigerator is an appliance which includes a main body provided with a storage chamber therein, a cold air supply system supplying cold air to the storage chamber, and a door opening and closing the storage chamber, thereby storing food in a fresh state.

The door of the refrigerator is normally in a closed state to prevent cold air in the storage chamber from escaping, and is opened for a user to put food into the refrigerator or to take food out of the refrigerator.

The door of the refrigerator may be rotatably coupled to a main body. In such a rotating door, when the door is opened to put food into the refrigerator or to take food out of the refrigerator in a state in which the refrigerator is not installed horizontally, the door may be automatically closed by its own weight.

### DISCLOSURE

### Technical Problem

The present disclosure is directed to providing a refrigerator capable of preventing a door from being automatically closed by a rotational momentum due to its own weight when a user opens the door to put food into the refrigerator or to take food out of the refrigerator.

The present disclosure is directed to providing a refrigerator in which a door closing preventer is disposed inside a door.

The present disclosure is directed to providing a refrigerator in which a door closing preventer is integrally formed on a shaft of a hinge.

### Technical Solution

One aspect of the present disclosure provides a refrigerator including a main body, a storage chamber formed inside the main body, a door coupled to the main body to open and close the storage chamber and on which a hinge groove is formed at a lower portion thereof, and a hinge coupled to the main body to rotatably support the door and having a shaft inserted into the hinge groove to form a rotation axis of the door, wherein the shaft includes a door closing preventer configured to prevent the door from being automatically closed when the door is opened at a predetermined angle, and wherein the door includes a locking part configured to prevent the door from being automatically closed by being caught on the door closing preventer when the door is opened at the predetermined angle.

The door closing preventer may be formed integrally with the shaft at an upper end of the shaft.

The door closing preventer may include a horizontal cam having a portion convexly protruding in a direction perpendicular to the rotation axis of the door.

The door may include a door cap provided on the lower portion of the door and on which the hinge groove is formed.

The door cap may include an outer wall forming the hinge groove, and the locking part may include an inner protrusion protruding from an inner circumferential surface of the outer wall toward the center of the hinge groove to be caught on the horizontal cam.

When the door is opened and the inner protrusion comes into contact with the horizontal cam, the inner protrusion may be elastically deformed such that the inner protrusion goes over the horizontal cam.

When the door is opened and the inner protrusion goes over the horizontal cam, the inner protrusion may be restored by an elastic force and caught on the horizontal cam so that the door is prevented from being automatically closed.

The locking part may include an elastic locking plate installed on the door cap.

When the door is opened and the elastic locking plate comes into contact with the horizontal cam, the elastic locking plate may be elastically deformed such that the elastic locking plate goes over the horizontal cam.

When the door is opened and the elastic locking plate goes over the horizontal cam, the elastic locking plate may be restored by an elastic force and caught on the horizontal cam so that the door is prevented from being automatically closed.

The door closing preventer may include a lower cam having a flexure portion formed on an upper surface thereof, and the locking part may include an upper cam having a flexure portion formed on a lower surface thereof to be engaged with the lower cam.

The lower cam and the upper cam each may include an top dead surface, a descending slope surface, a bottom dead surface, and an ascending slope surface, which are sequentially formed along a circumferential direction thereof.

The lower cam and the upper cam may interact to prevent the door from being automatically closed at all angles when the door is opened.

The lower cam and the upper cam each may include an top dead surface, a descending slope surface, a bottom dead surface, and a vertical surface, which are sequentially formed along a circumferential direction thereof.

### Advantageous Effects

According to the present disclosure, a door can be prevented from being automatically closed by a momentum due to its own weight in a state of being opened.

According to the present disclosure, a door closing preventer is not exposed to the outside by being disposed inside the door.

According to the present disclosure, the number of parts can be reduced and the structure can be simplified because the door closing preventer is integrally formed on a shaft of a hinge.

According to the present disclosure, the closing of the door can be prevented without the lifting and lowering movements of the door by using a horizontal cam and a locking ball.

### DESCRIPTION OF DRAWINGS

FIG. 1 is a perspective view of a refrigerator according to a first embodiment of the present disclosure.

FIG. 2 illustrates a structure for installing a door on a hinge of the refrigerator of FIG. 1.

FIG. 3 is an exploded view of main components of the hinge and the door of the refrigerator of FIG. 1.

FIG. 4 is a top cross-sectional view of the hinge and the door of the refrigerator of FIG. 1.

FIG. 5 is an enlarged cross-sectional view of a partial region of FIG. 4.

FIGS. 6 to 9 are views for explaining a function of a door closing preventer of the refrigerator of FIG. 1.

FIG. 10 illustrates a door closing preventer and a locking part according to a second embodiment of the present disclosure.

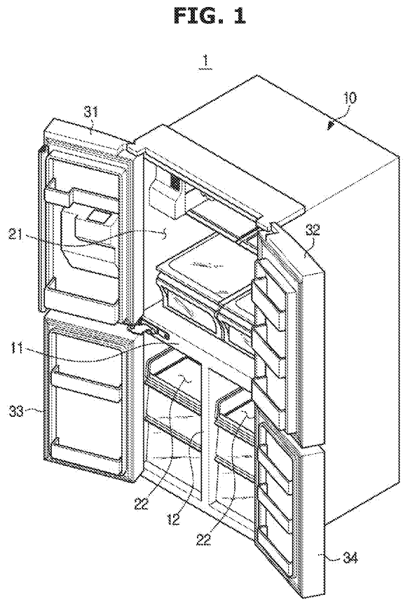

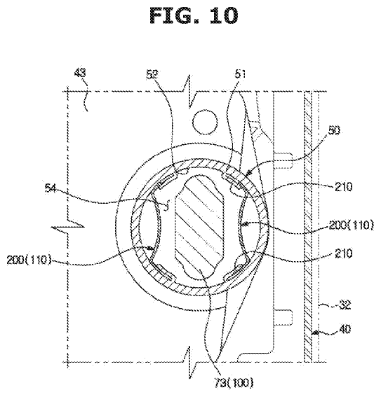

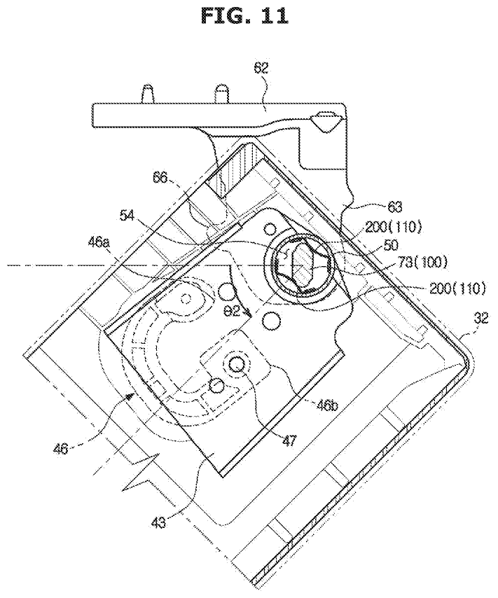

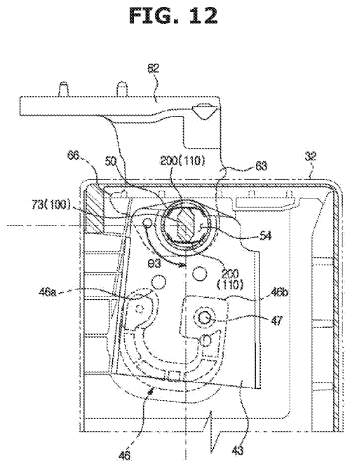

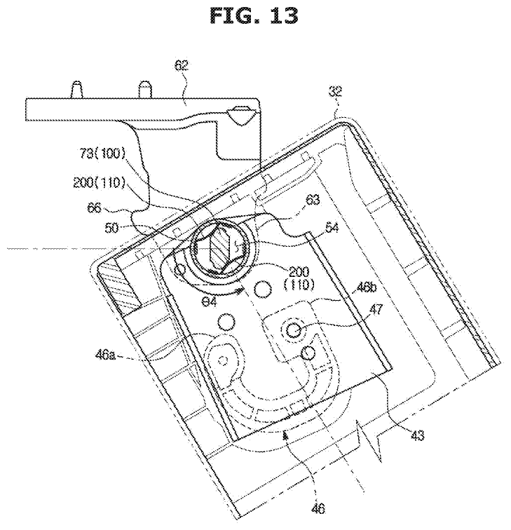

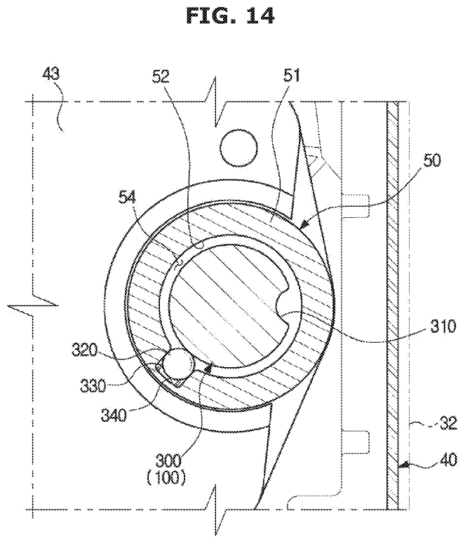

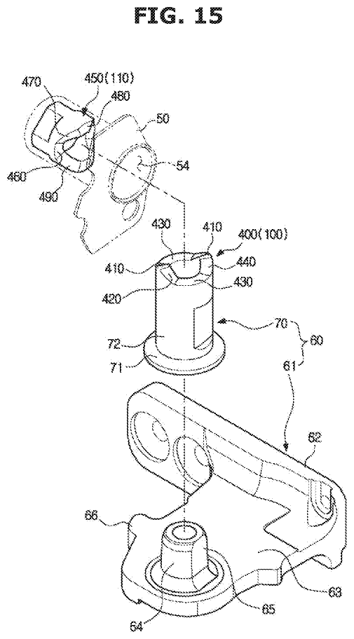

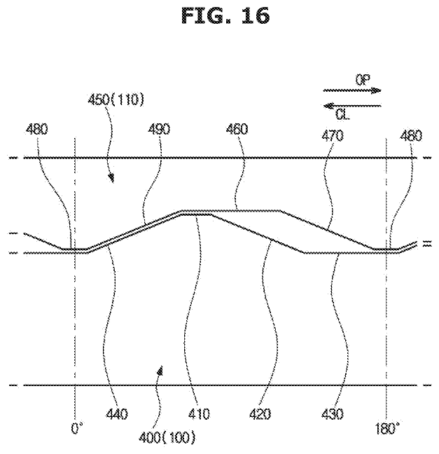

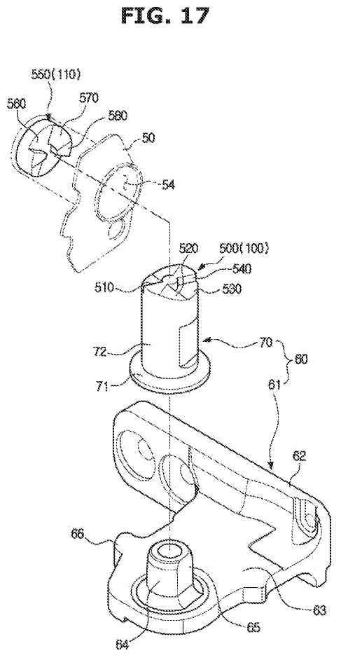

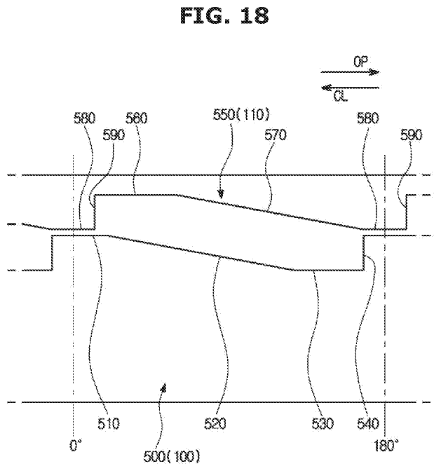

FIGS. 1I to 13 are views for explaining a function of the door closing preventer of the refrigerator of FIG. 10.

FIG. 14 illustrates a door closing preventer and a locking ball according to a third embodiment of the present disclosure.

FIG. 15 illustrates a door closing preventer and an upper cam according to a fourth embodiment of the present disclosure.

FIG. 16 is a side view of the upper cam and a lower cam of FIG. 15.

FIG. 17 illustrates a door closing preventer and an upper cam according to a fifth embodiment of the present disclosure.

FIG. 18 is a side view of the upper cam and a lower cam of FIG. 17.

### MODE OF THE DISCLOSURE

The embodiments described in the present specification and the configurations shown in the drawings are only examples of preferred embodiments of the present disclosure, and various modifications may be made at the time of filing of the present disclosure to replace the embodiments and drawings of the present specification.

Singular expressions used in the description may include plural expressions, unless the context clearly dictates otherwise. The shape and size of elements in the drawings may be exaggerated for clarity. Like reference numbers or signs in the various drawings of the application represent parts or components that perform substantially the same functions.

The terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms.

Hereinafter, embodiments of the present disclosure will be described in detail with reference to the accompanying drawings.

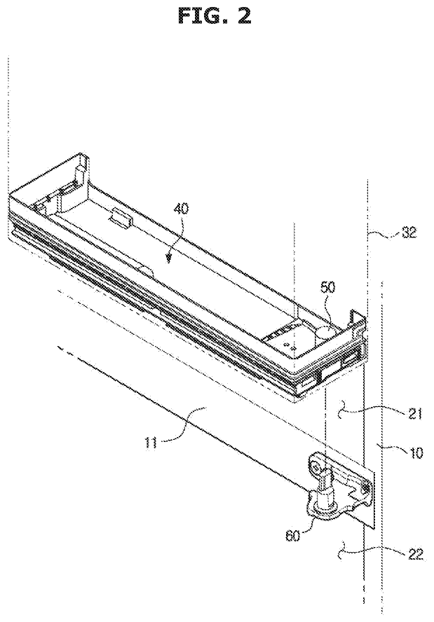

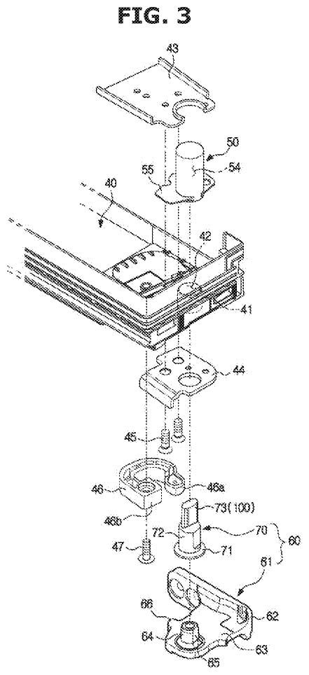

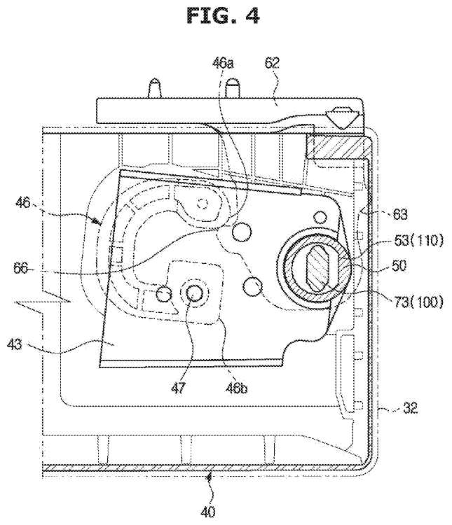

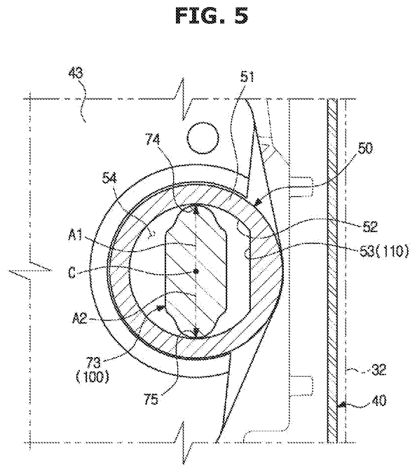

FIG. 1 is a perspective view of a refrigerator according to a first embodiment of the present disclosure. FIG. 2 illustrates a structure for installing a door on a hinge of the refrigerator of FIG. 1. FIG. 3 is an exploded view of main components of the hinge and the door of the refrigerator of FIG. 1. FIG. 4 is a top cross-sectional view of the hinge and the door of the refrigerator of FIG. 1. FIG. 5 is an enlarged cross-sectional view of a partial region of FIG. 4.

Referring to FIGS. 1 to 5, a refrigerator 1 may include a main body 10 having storage chambers 21 and 22, doors 31, 32, 33 and 34 coupled to the main body 10 to open and close the storage chambers 21 and 22, and a cold air supply device to supply cold air to the storage chambers 21 and 22.

The cold air supply device may include an evaporator, a compressor, a condenser, and an expanding device and may generate cold air by using evaporative latent heat of a refrigerant.

The main body 10 may include an inner case forming the storage chambers 21 and 22, an outer case coupled to an outer side of the inner case to form an outer appearance of the refrigerator 1, and insulation provided between the inner case and the outer case to insulate the storage chambers 21 and 22.

The main body 10 may include a horizontal partition wall 11 partitioning the storage chambers 21 and 22 into the upper storage chamber 21 and the lower storage chamber 22, and a vertical partition wall 12 partitioning the lower storage chamber 22 from side to side. The upper storage chamber 21 may be used as a refrigerating chamber for storing food in a refrigerating mode by maintaining indoor air at a temperature of about 0 to 5 degrees Celsius, and the lower storage chamber 22 may be used as a freezing chamber for storing food in a freezing mode by maintaining indoor air at a temperature of about 0 to −30 degrees Celsius.

The storage chambers 21 and 22 may have an open front to allow food to be received and withdrawn, and the open front of the storage chambers 21 and 22 may be opened and closed by the doors 31, 32, 33, and 34 rotatably provided in the front of the storage chambers 21 and 22.

Each of the door 31, 32, 33, and 34 may be rotatably supported by an upper hinge and a lower hinge. For example, a lunge 60 may be provided on a lower portion of the door 32 to rotatably support the door 32. Hereinafter, the hinge 60 provided on the lower portion of the door 32 will be described, but the hinge according to the present disclosure may be applied to not only the door 32 but also the other doors 31, 33, and 34.

The hinge 60 may include a hinge bracket 61 coupled to the main body 10, and a shaft 70 coupled to the hinge bracket 61 to form a rotation axis of the door 32. In the present embodiment, the hinge bracket 61 and the shaft 70 are provided separately and assembled with each other, but unlike this, the hinge bracket 61 and the shaft 70 may be integrally formed.

The hinge bracket 61 may include a main body coupling portion 62 having a substantially vertical plate shape and coupled to the main body 10, and an extension portion 63 extending forward from the main body coupling portion 62 and having a horizontal plate shape. The main body coupling portion 62 may be fastened to the main body 10 through fastening members such as screws, pins, and bolts.

A hinge pin 64 protruding upward may be formed on the extension portion 63, and the shaft 70 may be coupled to the hinge pin 64. A groove may be formed inside the shaft 70, and the hinge pin 64 may be inserted into the groove of the shaft 70. The hinge pin 64 may include a fixing surface 65 formed flat to prevent the shaft 70 from rotating. The extension portion 63 may be provided with a curved point 66 to allow an interference portion 46a of an automatic closing lever 46 to be caught thereto.

The shaft 70 may be inserted into a hinge groove 54 of a door cap 50 and may form a rotation axis C of the door 32. The shaft 70 may include a shaft body portion 72 formed in a substantially cylindrical shape to guide the rotation of the door 32 and a flange 71 protruding radially outward from a lower end of the shaft body portion 72 to be in close contact between a lower plate 40 of the door 32 and the extension portion 63 of the hinge bracket 61.

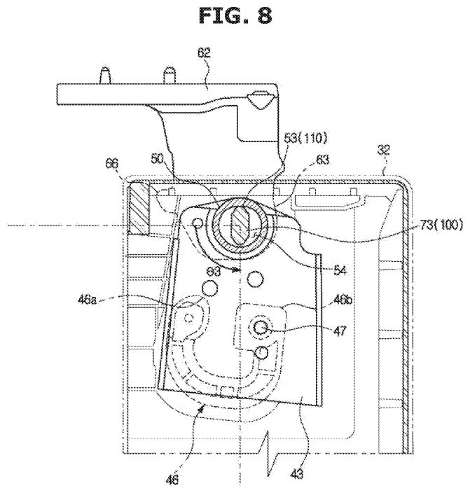

The shaft 70 may include a door closing preventer 100 configured to prevent the door 32 from being automatically closed by a momentum due to its own weight in a section in which an opening angle of the door 32 is larger than a predetermined angle θ3 (see FIG. 8).

The door closing preventer 100 may not be exposed to the outside by being disposed inside the hinge groove 54 of the door cap 50. The door closing preventer 100 may be integrally formed with the shaft body portion 72. The door closing preventer 100 may be formed on an upper end of the shaft body portion 72.

As illustrated in FIG. 5, the door closing preventer 100 may be a horizontal cam 73 having portions 74 and 75 protruding convexly in a direction perpendicular to the rotation axis C of the door 32. That is, the horizontal cam 73 may have the portion 74 protruding convexly in a first direction A1 perpendicular to the rotation axis C of the door 32 and the portion 75 protruding convexly in a second direction A2 opposite to the first direction A1 Therefore, the horizontal cam 73 may have a long rod-shaped cross section when viewed from above.

However, unlike the present embodiment, the horizontal cam 73 may be formed to have only one protruding portion, not a plurality of protruding portions.

The shaft 70 as above may be formed of a material such as plastic and rubber so that friction and noise may be reduced when the door 32 is rotated and the door 32 may rotate smoothly.

The door 32 may include a front plate forming a front surface of the door 32, a rear plate forming a rear surface of the door 32, an upper plate forming an upper surface of the door 32, and the lower plate 40 forming a lower surface of the door 32. Foam insulation may be provided inside the door 32.

A cylindrical portion 41 having a through hole 42 penetrating the lower plate 40 may be formed on the lower plate 40. The door 32 may include the door cap 50 coupled to the cylindrical portion 41. The hinge groove 54 may be formed inside the door cap 50, and a lower side of the lunge groove 54 may be opened. The shaft 70 may be inserted into the hinge groove 54. The door cap 50 may include a support portion 55 protruding outward in a radial direction.

The door 32 may include a coupling plate 43 coupled to an upper surface of the lower plate 40 to be in close contact with the support portion 55 of the door cap 50, and a reinforcing plate 44 coupled to a lower surface of the lower plate 40 to enhance a coupling force between the lower plate 40 and the door cap 50. The coupling plate 43 and the reinforcing plate 44 may be fastened to the lower plate 40 by a fastening member 45.

As the coupling plate 43 and the reinforcing plate 44 are fastened to the lower plate 40 and then the foam insulation is filled in the door 32, the door cap 50 may be securely fixed inside the door 32.

However, unlike the present embodiment, the door cap 50 and the lower plate 40 may be integrally formed.

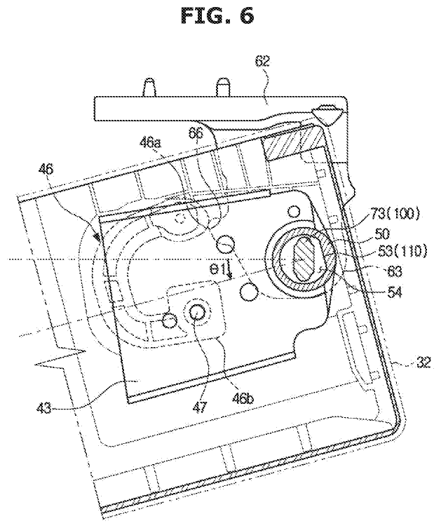

An automatic closing lever 46 may be coupled to the lower plate 40 of the door 32 in a section in which the opening angle of the door 32 is smaller than a predetermined angle θ1 (see FIG. 6).

The automatic closing lever 46 may be formed in a substantially U-shape, may have one end on which the fixing portion 46b is formed and the other end on which the interference portion 46a interfered by the curved point 66 of the hinge bracket 61 is formed. The fixing portion 46b may be firmly fastened to the lower plate 40 of the door 32 by a fastening member 47, and the interference portion 46a may move about the fixing portion 46b by interference with the hinge bracket 61.

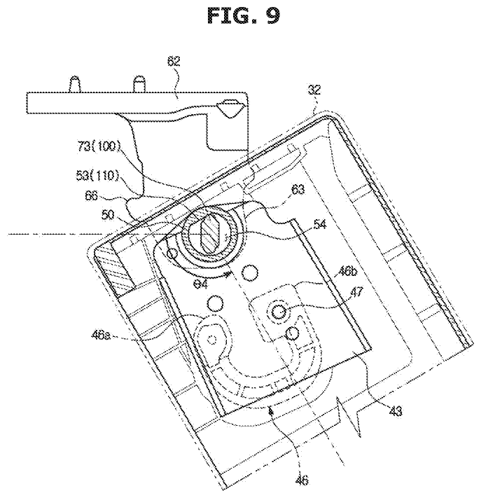

The door 32 may include a locking part 110 preventing the door 32 from being automatically closed by being caught on the door closing preventer 100 in a section in which the opening angle of the door 32 is larger than a predetermined angle θ4 (see FIG. 9). That is, in the section in which the opening angle of the door 32 is greater than the predetermined angle θ4 (see FIG. 9), the door 32 may be prevented from being automatically closed by its own weight as long as a user does not close the door 32 by applying an external force directly to the door 32.

The locking part 110 may be provided on the door cap 50. That is, the door cap 50 may include an outer wall 51 forming the hinge groove 54, and the locking part 110 may be an inner protrusion 53 protruding from an inner circumferential surface 52 of the outer wall 51 toward the center of the hinge groove 54.

FIGS. 6 to 9 are views for explaining a function of a door closing preventer of the refrigerator of FIG. 1.

A function of the door closing preventer 100 will be described through a rotation process of the door 32 with reference to FIGS. 6 to 9.

As illustrated in FIG. 6, the section in which the opening angle of the door 32 is smaller than the predetermined angle θ1 is a section in which the automatic closing lever 46 acts, and in this section, the door closing preventer 100 and locking part 110 may not function.

In this section, as the user pulls the door 32 to increase the opening angle of the door 32, the automatic closing lever 46 gradually opens and an elastic force thereof also increases. When the opening angle becomes the predetermined angle θ1, the automatic closing lever 46 opens to the maximum and the elastic force thereof is also maximized. In this section, when the user releases the door 32, the door 32 may be automatically closed by the elastic force of the automatic closing lever 46.

When the user opens the door 32 by further pulling the door 32 in a state in which the opening angle of the door 32 is the predetermined angle θ1, the interference portion 46a of the automatic closing lever 46 passes over the curved point 66 of the hinge bracket 61, so that the automatic closing lever 46 may be restored to its original state. Therefore, the automatic closing lever 46 may be no longer interfered by the hinge bracket 60.

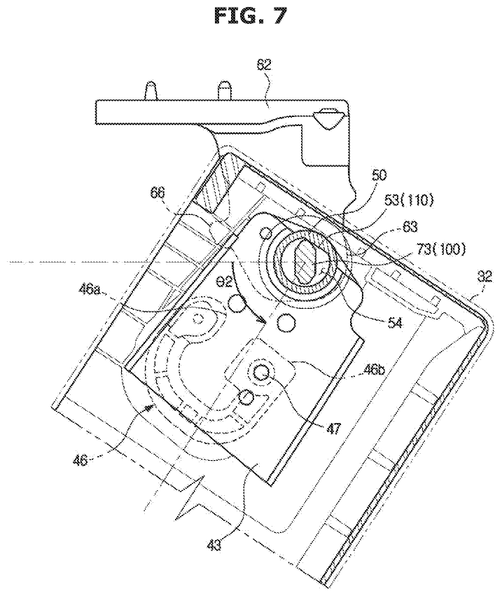

As illustrated in FIGS. 7 to 9, in a section in which the opening angle of the door 32 is between a predetermined angle θ2 and the predetermined angle θ4, the horizontal cam 73 and the inner protrusion 110 may interact. In this section, the inner protrusion 53 may be elastically deformed such that the inner protrusion 53 may go over the horizontal cam 73. The inner protrusion 53 may be elastically deformed to contract in a direction away from a center point of the hinge groove 54 as illustrated in FIG. 8.

Specifically, in a section in which the opening angle of the door 32 is between the predetermined angle θ2 and the predetermined angle θ3, as the user pulls the door 32 to increase the opening angle of the door 32, the deformation of the inner protrusion 53 becomes gradually large and the elastic force may be accumulated. When the user releases the door 32 in this section, the door 32 may be pressed in a closing direction by the elastic force accumulated in the inner protrusion 53. When the opening angle of the door 32 becomes the predetermined angle θ3, the deformation of the inner protrusion 53 and the accumulated elastic force may be maximized.

A section in which the opening angle of the door 32 is between the predetermined angle θ3 and the predetermined angle θ4, as the user pulls the door 32 to increase the opening angle of the door 32, the deformation of the inner protrusion 53 becomes gradually small and the elastic force may also be reduced. When the user releases the door 32 in this section, the door 32 may be pressed in an opening direction by the elastic force accumulated in the inner protrusion 53. When the opening angle of the door 32 becomes the predetermined angle θ4, the inner protrusion 53 is restored to its original state and the elastic force may disappear. Also, when the user releases the door 32 in this state, the inner protrusion 53 is caught on the horizontal cam 73 so that the door 32 may be prevented from being automatically closed.

The angles θ1, θ2, θ3, and θ4 may be appropriately determined in consideration of the detailed configuration of the refrigerator and the surrounding environment. In the present embodiment, the door closing preventer 100 is the horizontal cam 73, and a change in height of the door 32 may not occur when the door 32 is rotated. Therefore, an interval between the upper doors 31 and 32 and the lower doors 33 and 34 may be kept constant, and interference between parts such as the hinges and the doors may be prevented.

FIG. 10 illustrates a door closing preventer and a locking part according to a second embodiment of the present disclosure. FIGS. 11 to 13 are views for explaining a function of the door closing preventer of the refrigerator of FIG. 10.

A door closing preventer and a locking part according to the second embodiment of the present disclosure will be described with reference to FIGS. 10 to 13. The same reference numerals will be assigned to the same components as those in the above-described embodiment, and descriptions thereof may be omitted.

In the above-described embodiment, the locking part 110 is the inner protrusion 53 formed on the inner circumferential surface 52 of the door cap 50, but in the present embodiment, the locking part 110 may be an elastic locking plate 200 provided separately from the door cap 50.

A holder 210 configured to mount the elastic locking plate 200 may be formed on the inner circumferential surface 52 of the door cap 50, and the elastic locking plate 200 may be fitted into the holder 210 and disposed in the hinge groove 54 of the door cap 50.

In the present embodiment, a plurality of the elastic locking plates 200 is provided to face each other, but the present invention is not limited thereto, and only one of the elastic locking plate 200 may be provided. When only one of the elastic locking plate 200 is provided, the durability is slightly weakened, but the number of parts may decrease and the cost may be reduced.

A section in which the opening angle of the door 32 is smaller than the predetermined angle θ1 (see FIG. 6) is a section in which the automatic closing lever 46 acts, and it is the same as the above-described embodiment that the horizontal cam 100 and the elastic locking plate 200 do not act in this section.

As illustrated in FIGS. 11 to 12, in the section in which the opening angle of the door 32 is between the predetermined angle θ2 and the predetermined angle θ4, the horizontal cam 73 and the elastic locking plate 110 may interact. In this section, the inner protrusion 53 may be elastically deformed such that the elastic locking plate 110 may go over the horizontal cam 73.

Specifically, in the section in which the opening angle of the door 32 is between the predetermined angle θ2 and the predetermined angle θ3, as the user pulls the door 32 to increase the opening angle of the door 32, the deformation of the elastic locking plate 110 becomes gradually large and the elastic force may be accumulated. When the user releases the door 32 in this section, the door 32 may be pressed in the closing direction by the elastic force accumulated in the elastic locking plate 110. When the opening angle of the door 32 becomes the predetermined angle θ3, the deformation of the elastic locking plate 110 and the accumulated elastic force may be maximized.

The section in which the opening angle of the door 32 is between the predetermined angle θ3 and the predetermined angle θ4, as the user pulls the door 32 to increase the opening angle of the door 32, the deformation of the elastic locking plate 110 becomes gradually small and the elastic force may also be reduced. When the user releases the door 32 in this section, the door 32 may be pressed in the opening direction by the elastic force of the elastic locking plate 110. When the opening angle of the door 32 becomes the predetermined angle θ4, the elastic locking plate 110 is restored to its original state and the elastic force may disappear. Also, when the user releases the door 32 in this state, the elastic locking plate 110 is caught on the horizontal cam 73 so that the door 32 may be prevented from being automatically closed.

FIG. 14 illustrates a door closing preventer and a locking ball according to a third embodiment of the present disclosure.

A door closing preventer and a locking ball according to the third embodiment of the present disclosure will be described with reference to FIG. 14. The same reference numerals will be assigned to the same components as those in the above-described embodiment, and descriptions thereof may be omitted.

The door closing preventer 100 may be a locking member 300 disposed on an inner circumferential surface of the hinge groove 54. The locking member 300 may include a locking groove 310 formed on an outer circumferential surface thereof.

The door 32 may include a locking ball 320 that may be inserted into the locking groove 310 to fix the door 32. Specifically, a mounting groove 340 on which the locking ball 320 is mounted may be formed on the inner circumferential surface 52 of the door cap 50, and the locking ball 320 may be mounted in the mounting groove 340 to be able to move back and forth in a radial direction of the door cap 50.

An elastic member 330 elastically supporting the locking ball 320 to move the locking ball 320 toward the hinge groove 540 may be provided in the mounting groove 340.

The locking ball 320 may rotate with the door 32 in the rotational direction of the door 32 according to the rotation of the door 32. Therefore, when the door 32 rotates a predetermined angle, the locking ball 320 may move to a position corresponding to the locking groove 310 and may be inserted into the locking groove 310 by an elastic force of the elastic member 330. When the locking ball 320 is inserted into the locking groove 310, the door 32 is fixed so that the door 32 may be prevented from being automatically closed by its own weight.

FIG. 15 illustrates a door closing preventer and an upper cam according to a fourth embodiment of the present disclosure. FIG. 16 is a side view of the upper cam and a lower cam of FIG. 15.

A door closing preventer and an upper cam according to the third embodiment of the present disclosure will be described with reference to FIGS. 15 and 16. The same reference numerals will be assigned to the same components as those in the above-described embodiment, and descriptions thereof may be omitted.

The door closing preventer 100 may be a lower cam 400 having an top dead surface 410, a descending slope surface 420, a bottom dead surface 430, and an ascending slope surface 440 that are sequentially formed along a circumferential direction thereof.

The door cap 50 may include an upper cam 450 engaged with the lower cam 400 to prevent the door 32 from being closed. The upper cam 450 may have an top dead surface 460, a descending slope surface 470, a bottom dead surface 480, and an ascending slope surface 490 that are sequentially formed along a circumferential direction thereof to correspond to the lower cam 400.

With the above structure, when the user opens the door 32, the upper cam 450 rotates along an opening direction OP.

FIG. 16 is a side view illustrating the upper cam 450 and the lower cam 40) when the door 32 is closed, the bottom dead surface 480 of the upper cam 450 is seated on the bottom dead surface 430 of the lower cam 400, and the ascending slope surface 490 of the upper cam 450 is in close contact with the ascending slope surface 440 of the lower cam 400.

When the user opens the door 32 in this state, the upper cam 450 rises as the ascending slope surface 490 of the upper cam 450 slides on the ascending slope surface 440 of the lower cam 400 and then the upper cam 450 may descend again as the descending slope surface 470 of the upper cam 450 slides on the descending slope surface 420 of the lower cam 400.

When the user releases the door 32 in a state in which the lowering of the upper cam 450 is completed so that the bottom dead surface 480 of the upper cam 450 is seated on the bottom dead surface 430 of the lower cam 40) and the descending slope surface 470 of the upper cam 450 is in close contact with the descending slope surface 420 of the lower cam 40, the upper cam 450 may be prevented from being rotated in a closing direction CL by being caught on the lower cam 400.

FIG. 17 illustrates a door closing preventer and an upper cam according to a fifth embodiment of the present disclosure. FIG. 18 is a side view of the upper cam and a lower cam of FIG. 17.

A door closing preventer and an upper cam according to a fifth embodiment of the present disclosure will be described with reference to FIGS. 17 and 18. The same reference numerals will be assigned to the same components as those in the above-described embodiment, and descriptions thereof may be omitted.

The door closing preventer 100 may be a lower cam 500 having an top dead surface 510, a descending slope surface 520, a bottom dead surface 530, and a vertical surface 540 that are sequentially formed along the circumferential direction thereof.

In this case, the lower cam 500 may be configured not to receive resistance during rotation in a direction in which the door 32 is opened.

The door cap 50 may include an upper cam 550 engaged with the lower cam 500 to prevent the door 32 from being closed. The upper cam 550 may have an top dead surface 560, a descending slope surface 570, a bottom dead surface 580, and a vertical surface 590 that are sequentially formed along a circumferential direction thereof to correspond to the lower cam 500.

According to the above structure, the lower cam 500 and the upper cam 550 may interact to prevent the door 32 from being automatically closed at all opening angles when the door 32 is opened.

Specifically, FIG. 17 is a side view illustrating the upper cam 550 and the lower cam 500 when the door 32 is closed, and the bottom dead surface 580 of the upper cam 550 is seated on the bottom dead surface 530 of the lower cam 500.

When the user opens the door 32 in this state, the upper cam 550 may descend as the descending slope surface 570 of the upper cam 550 slides on the descending slope surface 520 of the lower cam 500.

When the lowering of the upper cam 550 is completed, the bottom dead surface 580 of the upper cam 550 may be seated on the bottom dead surface 530 of the lower cam 500. Therefore, in a section in which the door 32 is opened, the upper cam 550 does not receive a rotational force as the bottom dead surface 580 of the upper cam 550 is seated on the bottom dead surface 530 of the lower cam 500, or may receive a rotational force in the direction OP in which the door 32 is opened by the interaction of the descending slope surface 570 of the upper cam 550 and the descending slope surface 520 of the lower cam 500.

While the present disclosure has been particularly described with reference to exemplary embodiments, it should be understood by those of skilled in the art that various changes in form and details may be made without departing from the spirit and scope of the present disclosure.

1. A refrigerator comprising:
a main body;
a storage chamber formed inside the main body;
a door coupled to the main body to open and close the storage chamber and on which a hinge groove is formed at a lower portion thereof; and
a hinge coupled to the main body to rotatably support the door and having a shaft inserted into the hinge groove to form a rotation axis of the door,
wherein the shaft comprises a door closing preventer configured to prevent the door from being automatically closed when the door is opened at a predetermined angle, and
wherein the door comprises a locking part configured to prevent the door from being automatically closed by being caught on the door closing preventer when the door is opened at the predetermined angle.

2. The refrigerator according to claim 1, wherein
the door closing preventer is formed integrally with the shaft at an upper end of the shaft.

3. The refrigerator according to claim 1, wherein
the door closing preventer comprises a horizontal cam having a portion convexly protruding in a direction perpendicular to the rotation axis of the door.

4. The refrigerator according to claim 3, wherein
the door comprises a door cap provided on the lower portion of the door and on which the hinge groove is formed.

5. The refrigerator according to claim 4, wherein
the door cap comprises an outer wall forming the hinge groove, and
the locking part comprises an inner protrusion protruding from an inner circumferential surface of the outer wall toward the center of the hinge groove to be caught on the horizontal cam.

6. The refrigerator according to claim 5, wherein
when the door is opened and the inner protrusion comes into contact with the horizontal cam, the inner protrusion is elastically deformed such that the inner protrusion goes over the horizontal cam.

7. The refrigerator according to claim 6, wherein
when the door is opened and the inner protrusion goes over the horizontal cam, the inner protrusion is restored by an elastic force and caught on the horizontal cam so that the door is prevented from being automatically closed.

8. The refrigerator according to claim 4, wherein
the locking part comprises an elastic locking plate installed on the door cap.

9. The refrigerator according to claim 8, wherein
when the door is opened and the elastic locking plate comes into contact with the horizontal cam, the elastic locking plate is elastically deformed such that the elastic locking plate goes over the horizontal cam.

10. The refrigerator according to claim 9, wherein
when the door is opened and the elastic locking plate goes over the horizontal cam, the elastic locking plate is restored by an elastic force and caught on the horizontal cam so that the door is prevented from being automatically closed.

11. The refrigerator according to claim 1, wherein
the door closing preventer comprises a lower cam having a flexure portion formed on an upper surface thereof, and
the locking part comprises an upper cam having a flexure portion formed on a lower surface thereof to be engaged with the lower cam.

12. The refrigerator according to claim 11, wherein
the lower cam and the upper cam each comprise a top dead surface, a descending slope surface, a bottom dead surface, and an ascending slope surface, which are sequentially formed along a circumferential direction thereof.

13. The refrigerator according to claim 11, wherein
the lower cam and the upper cam interact to prevent the door from being automatically closed at all angles when the door is opened.

14. The refrigerator according to claim 13, wherein
the lower cam and the upper cam each comprise an top dead surface, a descending slope surface, a bottom dead surface, and a vertical surface, which are sequentially formed along a circumferential direction thereof.
